(19) United States
(12) Patent Application Publication
(10) Pub. No.: US 2008/0173252 A1
(43) Pub. Date: Jul. 24, 2008

(54) Automatic Pet Confinement Cleaning Device

(75) Inventor: Randal D. Boyd, Knoxville, TN (US)

Correspondence Address: PITTS AND BRITTIAN P C, P O BOX 51295, KNOXVILLE, TN, 37950-1295, US

(73) Assignee: Radio Systems Corporation, Knoxville, TN (US)

(21) Appl. No.: 11/624,676

(22) Filed: Jan. 18, 2007

(51) Int. Cl. A01K 1/015

(52) U.S. Cl. 119/479

(57) ABSTRACT

Described is a pet confinement cleaning device for automatically removing pet waste from a pet's structural confinement. The pet confinement cleaning device includes a confining structure, a conveyor belt device, and a receptacle. The confining structure is coupled to the frame of the conveyor belt device to create a pet confinement, whereby the confining structure serves as the walls and the ceiling of the pet confinement and a conveyor belt of the conveyor belt device serves as the flooring of the pet confinement. The receptacle is disposed proximately below the conveyor belt device such that when a pet deposits waste on the floor of the pet confinement, namely the conveyor belt, the conveyor belt device automatically moves the pet waste, in accordance with the operation of a conventional conveyor belt, to the receptacle.

### CROSS-REFERENCE TO RELATED APPLICATIONS

Not Applicable

### STATEMENT REGARDING FEDERALLY SPONSORED RESEARCH OR DEVELOPMENT

Not Applicable

### BACKGROUND OF THE INVENTION

1. Field of Invention

This invention pertains to a pet confinement cleaning device for automatically removing pet waste from a pet's structural confinement. More particularly, this invention pertains to a pet confinement cleaning device that includes a conveyor belt that serves as the flooring of the pet's structural confinement and that automatically moves pet waste deposited on the conveyor belt to a receptacle.

2. Description of the Related Art

An issue with keeping a small pet, such as a bird or a rodent, is that the pet must be kept within a small structural confinement, such as a cage, for at least extended periods of time. Because a small pet spends the majority of its existence within its confinement, the pet inevitably defecates, urinates, or otherwise deposits waste on the floor of its confinement. Conventional methods of removing pet waste from the floor of a pet's confinement include manually removing the waste with an instrument such as a scooping device. Additionally, some conventional pet confinements include a grate-type flooring that permits pet waste to fall through the grate flooring into tray-type receptacle, which is periodically emptied. Other conventional methods for removing pet waste from a pet's confinement include lining the floor of the pet's confinement with pads, newspaper, cedar chips, or another liner for absorbing waste, and replacing the liner when it becomes soiled.

Each of the conventional methods of removing pet waste from a pet confinement is limited in that the removal must be performed manually by the pet owner. Additionally, to maintain a healthy and habitable environment for the pet and the surrounding area, the pet confinement must be cleaned very regularly, typically multiple times daily. Most pet owners are not able to clean their pet's confinement multiple times daily, leaving their pets vulnerable to the detrimental health consequences associated with being exposed to pet waste. Consequently, a device that automatically removes pet waste from a pet's confinement to the extent that the pet is not exposed to detrimental heath consequences is desired.

### BRIEF SUMMARY OF THE INVENTION

In accordance with the various features of the present invention there is provided a pet confinement cleaning device for automatically removing pet waste from a pet's structural confinement. The pet confinement cleaning device includes a confining structure, a conveyor belt device, and a receptacle. The confining structure is a structure that defines an enclosure for confining a pet, such as a cage. The conveyor belt device includes a frame and a conventional conveyor belt configuration. The receptacle is an open-top box-type structure, such as a drawer. The confining structure is coupled to the frame of the conveyor belt device to create a pet confinement, whereby the confining structure serves as the walls and the ceiling of the pet confinement and the conveyor belt of the conveyor belt device serves as the flooring of the pet confinement. The receptacle is disposed proximately below the conveyor belt device such that the receptacle serves as a sub-flooring for the pet confinement. When a pet deposits waste on the floor of the pet confinement, namely the conveyor belt, the conveyor belt device automatically moves the pet waste, in accordance with the operation of a conventional conveyor belt, to the receptacle. After the pet waste is moved to the receptacle, the pet confinement is free of the pet waste and the pet is not susceptible to the detrimental health consequences associated with being exposed to pet waste.

### BRIEF DESCRIPTION OF THE SEVERAL VIEWS OF THE DRAWINGS

The above-mentioned features of the invention will become more clearly understood from the following detailed description of the invention read together with the drawings in which:

FIG. 1a is an exploded view of the pet confinement cleaning device illustrating various features of the present invention.

FIG. 1b is a perspective view of the pet confinement cleaning device illustrating various features of the present invention.

FIG. 2 illustrates the conveyor belt device of the pet confinement cleaning device in accordance with various features of the present invention.

FIG. 3 illustrates the receptacle of the pet confinement cleaning device in accordance with various features of the present invention.

FIGS. 4a-4d are exploded views of the conveyor belt device and the receptacle illustrating operative features of the pet confinement cleaning device.

FIG. 5 illustrates an alternate embodiment of the pet confinement cleaning device that includes a pet blocking portion.

FIG. 6 illustrates an alternate embodiment of the pet confinement cleaning device that includes a chip dispensing device.

FIG. 7 illustrates an alternate embodiment of the pet confinement cleaning device that includes non-continuous conveyor belt configuration.

### DETAILED DESCRIPTION OF THE INVENTION

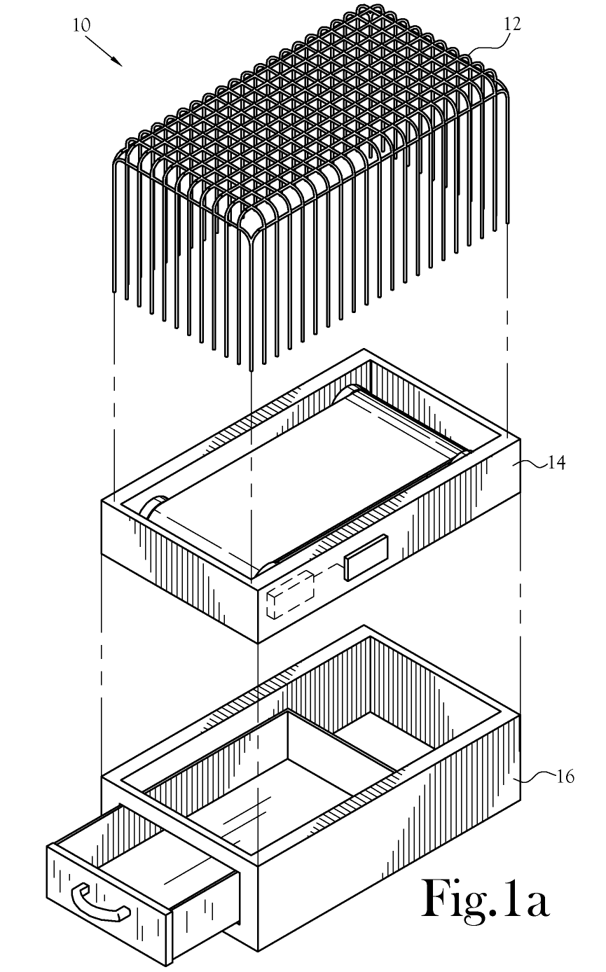

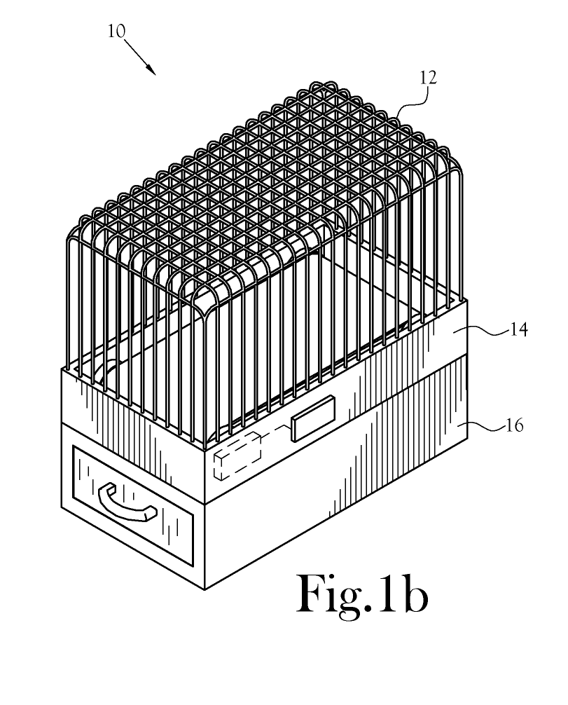

One embodiment of a pet confinement cleaning device for automatically removing pet waste from a pet's structural confinement and constructed in accordance with the various features of the present invention is illustrated generally at 10 in FIG. 1. The pet confinement cleaning device 10 includes a confining structure, a conveyor belt device, and a receptacle. The confining structure is a structure that defines an enclosure for confining a pet, such as a cage. The conveyor belt device includes a frame and a conventional conveyor belt configuration. The receptacle is an open-top box-type structure, such as a drawer. The confining structure is coupled to the frame of the conveyor belt device to create a pet confinement, whereby the confining structure serves as the walls and the ceiling of the pet confinement and the conveyor belt of the conveyor belt device serves as the flooring of the pet confinement. The receptacle is disposed proximately below the conveyor belt device such that the receptacle serves as a sub-flooring for the pet confinement. When a pet deposits waste on the floor of the pet confinement, namely the conveyor belt, the conveyor belt device automatically moves the pet waste, in accordance with the operation of a conventional conveyor belt, to the receptacle. After the pet waste is moved to the receptacle, the pet confinement is free of the pet waste and the pet is not susceptible to the detrimental health consequences associated with being exposed to pet waste.

FIG. 1a is an exploded view of the pet confinement cleaning device 10 depicting various features of the present invention, and FIG. 1b is a perspective view of the pet confinement cleaning device 10 depicting various features of the present invention. The pet confinement cleaning device 10 includes a confining structure 12, a conveyor belt device 14, and a receptacle 16. The confining structure 12 is a structure that defines an enclosure and is for confining a pet within the enclosure. The confining structure 12 of the illustrated embodiment is a conventional wire pet cage, commonly used to confine small birds and small animals. Those skilled in the art will recognize that the confining structure 12 can be any pet confining structure, such as an open-top or closed-top glass or plastic confinement, without departing from the scope or spirit of the present invention. The confining structure 12 is coupled to the conveyor belt device 14 such that when coupled, the confining structure 12 and the conveyor belt device 14 form an enclosure, namely the pet confinement. More specifically, the conveyor belt device 14 serves as the flooring of the pet confinement and the confining structure 12 serves as the confining structure of the pet confinement, which, in the illustrated embodiment, includes the wire walls and ceiling of the cage. The receptacle 16 is adapted to receive pet waste from the conveyor belt device 12 and is disposed proximately below the conveyor belt device 14. In the illustrated embodiment, the receptacle 16 serves as the sub-flooring of the pet confinement. Also in the illustrated embodiment, the receptacle 16 includes an open-top removable drawer and structurally supports the pet confinement, namely the confining structure 12 and the conveyor belt device 14. Those skilled in the art will recognize that the receptacle 16 can be a device that does not include a removable drawer, such as an open-top box, without departing from the scope or spirit of the present invention. Those skilled in the art will also recognize that the receptacle 16 need not provide structural support to the pet confinement to remain within the scope and spirit of the present invention.

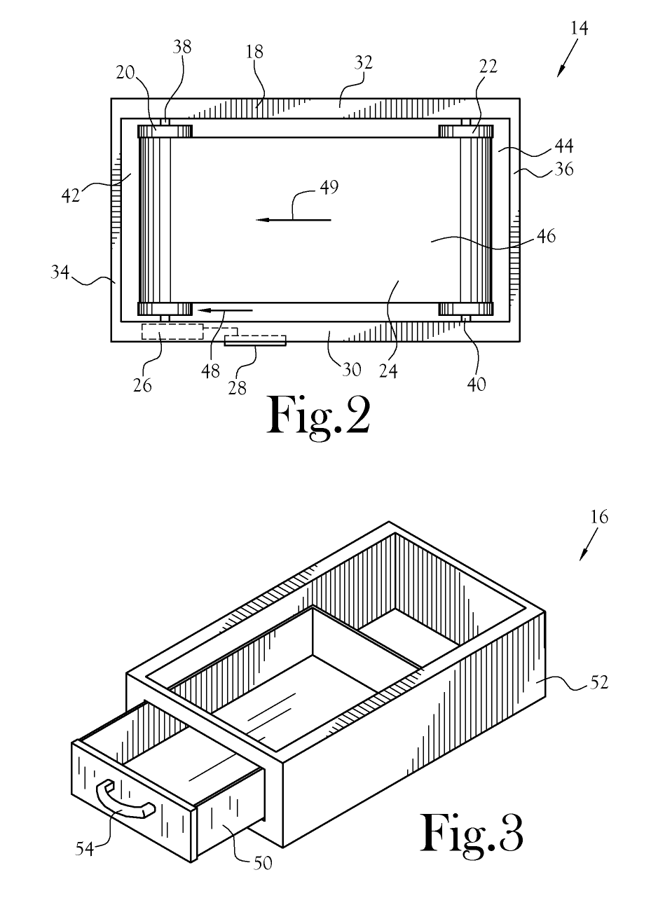

FIG. 2 illustrates the conveyor belt device 14 in accordance with the various features of the present invention. The conveyor belt device 14 includes a frame 18, a drive roller 20, an idle roller 22, a belt 24, a rotary driver 26, and a controller 28. The frame 18 defines the perimeter of the flooring of the pet confinement and is coupled to the confining structure 12 as discussed above. The frame 18 defines an open geometric shape in accordance with the geometric shape of the confining structure 12. For example, in the illustrated embodiment, the frame 18 defines an open rectangle in accordance with the rectangular shape of the confining structure 12. Those skilled in the art will recognize that the frame 18 can be constructed such that it does not define a geometric shape in accordance with the geometric shape of the confining structure 12 without departing from the scope or spirit of the present invention. Additionally, those skilled in the art will recognize that the frame 18 can be constructed such that it does not define a geometric shape without departing from the scope or spirit of the present invention. The frame 18 of the illustrated embodiment includes a first side 30, a second side 32, a first end 34, and a second end 36. Additionally, the conveyor belt device 14 includes a drive roller pin 38 and an idle roller pin 40. The drive roller pin 38 and the idle roller pin 40 are disposed coaxially within the drive roller 20 and idle roller 22 respectively. The pins are secured immovably within each roller and extend beyond the rollers at both ends. The frame 18 is adapted to matingly receive the extending portions of the drive roller pin 38 and the idle roller pin 40. More specifically, one end of the drive roller pin 38 is received by the first side 30 of the frame 18, and the opposite end of the drive roller pin 38 is received by the second side 32 of the frame 18 such that the drive roller 20 is disposed within the open geometric shape defined by the frame 18. Additionally, the frame 18 receives the drive roller pin 38 such that the drive roller pin 38 rotates within the frame 18 to the extent that the drive roller 20 rotates about its longitudinal axis. In similar fashion, one end of the idle roller pin 40 is received by the first side 30 of the frame 18, and the opposite end of the idle roller pin 40 is received by the second side 32 of the frame 18 such that the idle roller 22 is disposed within the open geometric shape defined by the frame 18. Additionally, the frame 18 receives the idle roller pin 40 such that the idle roller pin 40 rotates within the frame 18 to the extent that the idle roller 22 rotates about its longitudinal axis. The drive roller 20 is disposed proximate to the first end 34 of the frame 18 such that the drive roller 20 and the first end 34 define a first open area 42 between the drive roller 20 and the first end 34. Similarly, the idle roller 22 is disposed proximate to the second end 36 of the frame 18 such that the idle roller 22 and the second end 36 define a second open area 44 between the idle roller 22 and the second end 36.

The belt 24 is a continuous loop of material disposed around and in mechanical contact with the drive roller 20 and the idle roller 22 such that the belt 24, the drive roller 20, and the idle roller 22 generate a conventional conveyor belt configuration. A result of this configuration is that the belt 24 defines a level surface 46 between the drive roller 20 and the idle roller 22. The level surface 46 serves as the flooring of the pet confinement. Additionally, the width of the belt 24 is substantially equivalent to the distance between the first side 30 and the second side 32 of the frame 18. The mechanical contact between the belt 24 and the drive roller 20 is such that when the drive roller 20 rotates in a particular direction, such as counter-clockwise, the belt 24 rotates in the same direction. Additionally, the mechanical contact between the belt 24 and the idle roller 22 is such that when the drive roller 20 rotates in a particular direction, causing the belt 24 to rotate in that same particular direction, the idle roller 22 rotates in that same particular direction. Those skilled in the art will recognize that the belt 24 can be a non-continuous piece of material without departing from the scope or spirit of the present invention. The belt 24 in the illustrated embodiment is constructed of a nonabsorbent material, such as rubber. However, those skilled in the art will recognize that the belt 24 can be treated with a coating to give the belt 24 nonabsorbent properties without departing from the scope or spirit of the present invention. Additionally, those skilled in the art will recognize that the belt 24 can be constructed of an absorbent material without departing from the scope or spirit of the present invention. For example, a belt 24 constructed of an absorbent material is desired for various subsequently discussed embodiments of the pet confinement cleaning device 10.

Those skilled in the art will recognize that the drive roller 20 and the idle roller 22 can each be a structure other than a cylindrical structure that extends the width of the belt 24, as depicted in the illustrated embodiment, without departing from the scope or spirit of the present invention. For example, the structure of each the drive roller 20 and the idle roller 22 includes a pair of pulleys disposed proximate to the first side 30 and the second side 32 respectively such that the substantial width of the belt 24 extends between each pair of pulleys, defining the level surface 46.

As discussed above, the drive roller 20 is disposed proximate to the first end 34 of the frame 18 and the idle roller 22 is disposed proximate to the second end 36 of the frame 18. The drive roller 20 is disposed such that the first open area 42 is sufficiently large to allow pet waste to pass between the first end 34 and the belt 24 at the drive roller 20. Additionally, the drive roller 20 and the idle roller 22 must be disposed sufficiently close to the first end 34 and the second end 36 respectively such that the level surface 46 is sufficiently large to provide adequate flooring for the pet confinement.

The rotary driver 26 rotates the drive roller 20. In the illustrated embodiment, the rotary driver 26 is a motor that is mechanically engaged with the drive roller pin 38 such that the rotary driver 26 rotates the drive roller pin 38, and consequently the drive roller 20, in a counter-clockwise direction, as depicted at 48. When the rotary driver 26 rotates the drive roller 20 in a counter-clockwise direction, the belt 24 and the idle roller 22 rotate in a counter-clockwise direction. As a result, the level surface 46 shifts in the direction of the first end 34, as depicted at 49. Those skilled in the art will recognize that the rotary driver 26 can rotate the drive roller 20 without being in mechanical contact with the drive roller pin 38 without departing from the scope or spirit of the present invention.

In the illustrated embodiment, the rotary driver 26 is in electrical communication with the controller 28. The controller 28 includes a user interface and governs the operation of the rotary driver 26. The controller 28 is programmed by a user to automatically activate the rotary driver 26 at a programmed moment in time. In the illustrated embodiment, the controller 28 includes a processing unit that maintains a standard clock and a user interface that displays the time kept by the clock. The controller 28 permits the user to program a desired time by way of the user interface, whereby the controller 28 automatically activates the rotary driver 26 at that programmed time.

Those skilled in the art will recognize that the controller 28 can be in communication with the rotary driver 26 in ways other than electrical communication, such as mechanical communication or wireless communication, without departing from the scope or spirit of the present invention. Those skilled in the art will also recognize that the settings provided by the controller 28 can vary in complexity without departing from the scope or spirit of the present invention. For example, the controller 28 can include a processing unit that permits the controller 28 to automatically activate and deactivate the rotary driver 26 periodically or at certain pre-programmed times. Additionally, the controller 28 can activate the rotary driver 26 such that the rotary driver 26 rotates the drive roller 20 in the direction desired by the user, namely clockwise or counter-clockwise, without departing from the scope or spirit of the present invention.

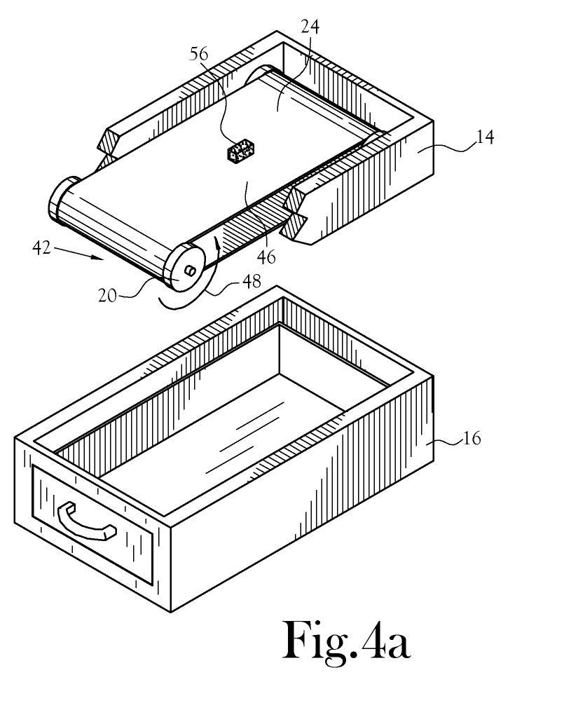

FIG. 3 illustrates the receptacle 16 in accordance with various features of the present invention. As discussed above, the receptacle 16 is adapted to receive pet waste from the conveyor belt device 14. In the illustrated embodiment, the receptacle 16 includes a drawer portion 50 and a sheath portion 52. The drawer portion 50 is a conventional open-top drawer. The sheath portion 52 is an open-top structure that receives the drawer portion 50 in a conventional drawer-type manner. As previously discussed, in the illustrated embodiment, the sheath portion 52 is disposed below and is coupled with the frame 18 of the conveyor belt device 14 such that the sheath portion 52 provides structural support for the conveyor belt device 14 and the confining structure 12. The drawer portion 50 is removable from the sheath portion 52 and includes a handle 54 to facilitate such removal by the user of the pet confinement cleaning device 10. The receptacle 16 is constructed such that when coupled with the conveyor belt device 14, at least a part of the storage section of the drawer portion 50 is directly below the first open area 42.

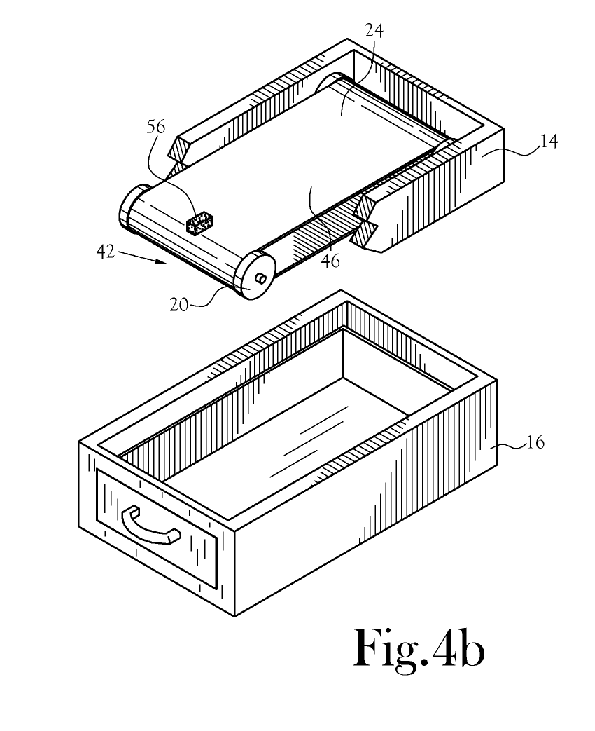

FIG. 4 is an exploded view of the conveyor belt device 14 and the receptacle 16 illustrating various features of the present invention. Because the belt 24 of the conveyor belt device 14 serves as the flooring of the pet confinement, a pet kept within the pet confinement will inevitably deposit pet waste on the belt 24. This pet waste is represented by a box and is depicted at 56. FIG. 4a illustrates the situation where the pet deposits pet waste 56 near the center of the level surface 46 defined by the belt 24. Some time after the deposit and at the time programmed by the user, the controller 28 activates the rotary driver 26 such that the rotary driver 26 rotates the drive roller 20 in a counter-clockwise direction. As a result, the belt 24 rotates in a counter-clockwise direction moving the pet waste 56 toward the first open area 42, as depicted in FIG. 4b. As the rotary driver 26 continues to rotate the drive roller 20, the pet waste 56, in due time, is moved to the first open area 42. As the portion of the belt 24 on which the pet waste 56 was deposited wraps around the drive roller 20, gravity forces the pet waste 56 from the belt 24 and through the first open area 42, as depicted in FIG. 4c. After passing through the first open area 42, the pet waste 56 falls into the drawer portion 50 of the receptacle 16, as depicted in FIG. 4d. After the pet waste 56 falls into the receptacle 16, the pet confinement is free of pet waste and the pet is not susceptible to the detrimental health consequences associated with being exposed to pet waste. Additionally, after the pet waste 56 falls into the drawer portion 50 of the receptacle 16, the user removes the drawer portion 50 from the sheath portion 52 to permanently dispose of the pet waste 56. Because the pet waste 56 is kept in the receptacle 16 until it is permanently disposed of, and is not kept within the pet confinement, the user can permanently dispose of the pet waste 56 at his convenience, without being concerned with the heath of his pet.

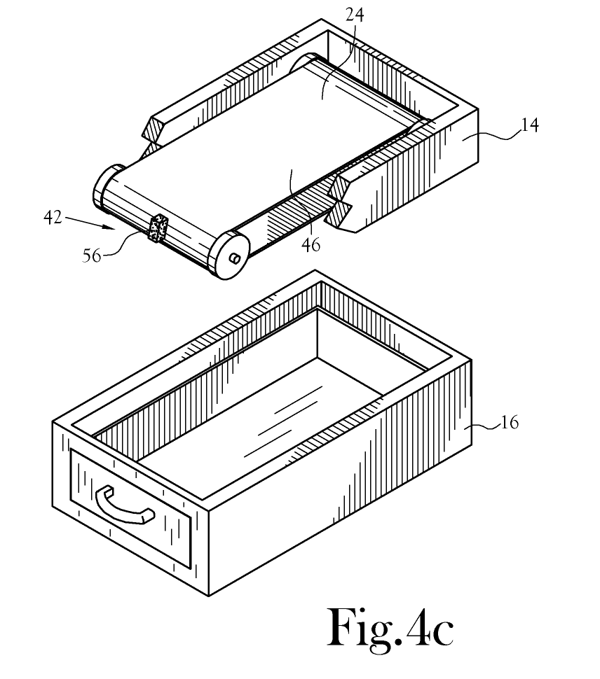

FIG. 5 illustrates an alternate embodiment of the conveyor belt device 14 in accordance with various features of the present invention. In the alternate embodiment, the conveyor belt device 14 includes a pet blocking portion 58. In the illustrated embodiment, the pet blocking portion 58 is a block of rigid material that is secured to the frame 18 at the first end 34 of the conveyor belt device 14. The pet blocking portion 58 is disposed directly above the first open area 42 and extends from the first end 34 to at least the belt 24 at the drive roller 20 such that the first open area 42 is completely concealed when viewed from directly above. The pet blocking portion 58 defines a passing space 62 between the pet blocking portion 58 and the belt 24. The passing space 62 is sufficiently large to allow pet waste to pass through the passing space 62 and to the first open area 42 in accordance with the discussed features of the present invention. At the same time, the passing space 62 is sufficiently small to prevent the pet from passing through the passing space 62 and to the first open area 42, where the pet has potential to fall through the first open area 42, become lodged within the first open area 42, or otherwise be harmed by the mechanics of the conveyor belt device 14.

Those skilled in the art will recognize that the pet blocking portion 58 can be constructed of a material that is not rigid and can be a shape other than a block without departing from the scope or spirit of the present invention.

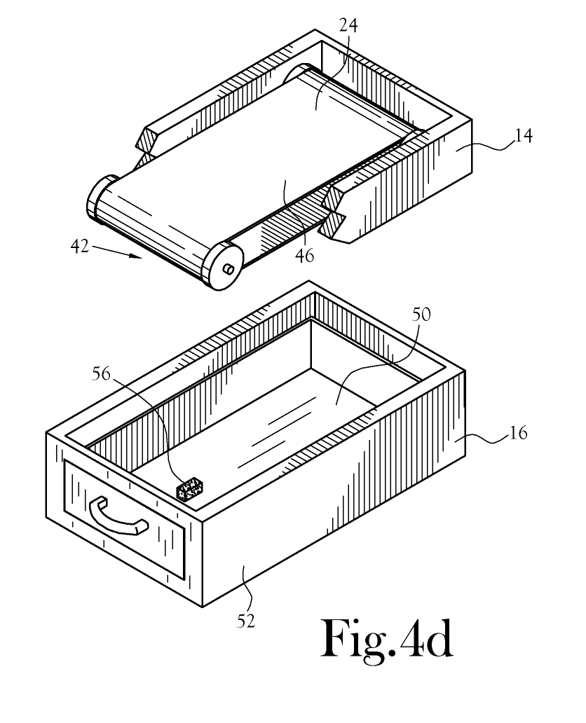

FIG. 6 illustrates an alternate embodiment of the conveyor belt device 14 in accordance with various features of the present invention. In the alternate embodiment, the conveyor belt device 14 includes a chip dispensing device 64 for dispensing cedar chips. The chip dispensing device 64 is secured to the frame 18 at the second end 36 of the conveyor belt device 14 and is in electrical communication with the controller 28. When the controller 28 activates the rotary driver 26, the controller 28 activates the chip dispensing device 64. The activated chip dispensing device 64 dispenses cedar chips onto the belt 24. Because the controller 28 activates the rotary driver 26 and chip dispensing device 64 concurrently, the chip dispensing device 64 dispenses cedar chips onto the belt 24 as the belt 24 rotates, lining the level surface 46 of the belt 24, namely the flooring of the pet confinement, with cedar chips. Additionally, when the conveyor belt device 14 rotates the belt 24 in the direction of the first open area 42 as discussed above, the cedar chips, along with the pet waste, pass through the first open area 42 to the receptacle 16. This alternate embodiment of the conveyor belt device 14 permits a pet owner to automatically line the flooring of the pet confinement with cedar chips in conformance with conventional practice of lining the flooring of a pet cage with cedar chips. Those skilled in the art will recognize that a lining other than cedar chips can be used without departing from the scope or spirit of the present invention.

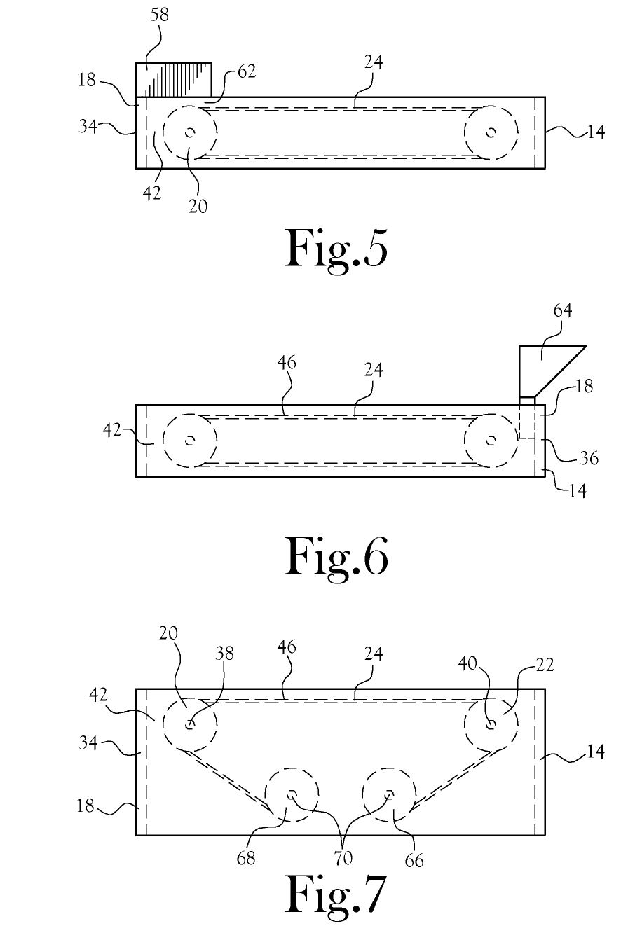

FIG. 7 illustrates an alternate embodiment of the conveyor belt device 14 in accordance with various features of the present invention. In the alternate embodiment, the conveyor belt device 14 includes a feeding spool 66 and a collecting spool 68. The feeding spool 66 is disposed below the idle roller 22 and between the vertical plane on which the drive roller 20 is disposed and the vertical plane on which the idle roller 22 is disposed. The collecting spool 68 is disposed below the drive roller 20 and between the vertical plane on which the drive roller 20 is disposed and the vertical plane on which the idle roller 22 is disposed. Both the feeding spool 66 and the collecting spool 68 include a spool pin 70 that is disposed coaxially and secured immovably within each spool and extends beyond the spools at both ends. The frame 18 matingly receives the spool pins 70 in the same fashion that the frame 18 matingly receives the drive roller pin 38 and the idle roller pin 40. Consequently, the feeding spool 66 and the collecting spool 68 rotate about their respective longitudinal axis. The feeding spool 66 and the collecting spool 68 are adapted to receive the belt 24 such that the belt is wound on the spools. Additionally, in the alternate embodiment, the belt 24 is not a continuous loop of material, but includes a first end and a second end. The belt 24 is wound on the feeding spool 66 at the second end of the belt 24. From the feeding spool 66, the belt 24 extends to the idle roller 22 and is in mechanical contact with the idle roller 22 as discussed above. The belt 24 extends from the idle roller 22 to the drive roller 20, generating the level surface 46, and is in mechanical contact with the drive roller 20 as discussed above. The belt 24 extends from the drive roller 20 to the collecting spool 68, where the belt 24 is wound on the collecting spool 68 at the first end of the belt 24. Additionally, the rotary driver 26 is mechanically engaged with the spool pin 70 of the collecting spool 68 such that when the rotary driver 26 rotates the drive roller 20, the rotary driver 26 rotates the collecting spool 68.

In the illustrated alternate embodiment, the belt 24 is constructed of a disposable, absorbent material, such as a paper-based material. Those skilled in the art will recognize that the belt 24 can be constructed of a material that is neither absorbent nor disposable without departing from the scope or spirit of the present invention. The unused portion of the belt 24 is wound on the feeding spool 66. As the rotary driver 26 rotates the belt 24 toward the first end 34, the unused portion of the belt 24 is unwound from the feeding spool 66 and positioned between the drive roller 20 and the idle roller 22 such that the unused portion of the belt 24 generates the level surface 46, which is the flooring of the pet confinement. After the pet deposits waste on the unused portion of the belt 24, that portion of the belt 24 becomes used. Additionally, after the pet deposits waste on the belt 24, the rotary driver 26 rotates the belt 24 toward the first end 34 in accordance with the features of the present invention discussed above, moving the pet waste toward the first open area 42. Because the rotary driver 26 is rotating the collecting spool 68 as it is rotating the drive roller 20, the used portion of the belt 24 is wound on the collecting spool 68 after the used portion of the belt 24 rotates past the drive roller 20. Consequently, after the pet waste falls to the receptacle 16 in accordance with the features of the present invention discussed above, the used portion of the belt 24 is collected on the collecting spool 68. When the substantial entirety of the belt 24 has been used, the pet owner can remove the used belt 24 from the collecting spool 68 and permanently dispose of the used belt 24.

From the foregoing description, those skilled in the art will recognize that a device for automatically cleaning a pet confinement offering advantages over the prior art has been provided. The device provides a conveyor belt configuration for automatically moving pet waste from the pet confinement. Further, the device provides a receptacle for collecting pet waste such that the pet owner disposes of the pet waste at his convenience without jeopardizing the health of the pet.

While the present invention has been illustrated by description of several embodiments and while the illustrative embodiments have been described in considerable detail, it is not the intention of the applicant to restrict or in any way limit the scope of the appended claims to such detail. Additional advantages and modifications will readily appear to those skilled in the art. The invention in its broader aspects is therefore not limited to the specific details, representative apparatus and methods, and illustrative examples shown and described. Accordingly, departures may be made from such details without departing from the spirit or scope of applicant's general inventive concept.

Having thus described the aforementioned invention, we claim:

1. A pet confinement cleaning device for automatically removing pet waste from a pet confinement, said pet confinement cleaning device comprising:
a frame;
a drive roller, said drive roller secured to said frame such that said drive roller rotates about its longitudinal axis;
an idle roller, said idle roller secured to said frame such that said idle roller rotates about its longitudinal axis;
a belt, said belt disposed around said drive roller and said idle roller such that said belt, said drive roller, and said idle roller are configured to operate as a conveyor belt configuration, whereby rotating said drive roller rotates said belt, said belt being the flooring for the pet confinement;
a rotary driver, said rotary driver mechanically engaged with said drive roller, said rotary driver rotates said drive roller;
a controller, said controller in communication with said rotary driver, said controller activates said rotary driver, said controller capable of being programmed to activate said rotary driver at a preprogrammed time; and
a receptacle, said receptacle disposed proximately below said drive roller, said idle roller, and said belt.

2. The pet confinement cleaning device of claim 1 further comprising a confining structure, said confining structure secured to said frame such that said confining structure and said belt define the pet confinement.

3. The pet confinement cleaning device of claim 1 wherein said frame couples with a confining structure such that the confining structure and said belt define the pet confinement.

4. The pet confinement cleaning device of claim 1 wherein said frame and said drive roller define an open area between said frame and said drive roller, whereby pet waste deposited on said belt passes through the open area as the portion of said belt on which the pet waste was deposited wraps around said drive roller.

5. The pet confinement cleaning device of claim 4 wherein said receptacle is aligned under the open area defined by said frame and said drive roller such that pet waste passing through the open area falls under the force of gravity into said receptacle.

6. The pet confinement cleaning device of claim 4 further comprising a pet blocking portion, said pet blocking portion secured to said frame, said pet blocking portion for permitting pet waste access to the open area and preventing a pet access to the open area.

7. The pet confinement cleaning device of claim 1 wherein said idle roller is immovably secured to said frame such that said idle roller does not rotate.

8. The pet confinement cleaning device of claim 1 wherein said belt is a continuous loop of material.

9. The pet confinement cleaning device of claim 1 wherein said belt is constructed of a nonabsorbent material.

10. The pet confinement cleaning device of claim 1 wherein said belt is treated with a nonabsorbent coating.

11. The pet confinement cleaning device of claim 1 wherein said rotary driver is an electric motor.

12. The pet confinement cleaning device of claim 1 wherein said controller includes a user interface for facilitating the programming of said controller.

13. The pet confinement cleaning device of claim 1 wherein said receptacle is an open-top box.

14. The pet confinement cleaning device of claim 1 wherein said receptacle includes a removable drawer portion.

15. A pet confinement cleaning device for automatically removing pet waste from a pet confinement, said pet confinement cleaning device comprising:
a conveyor belt device, said conveyor belt device including a conveyor belt configuration, said conveyor belt device including a rotary driver, the rotary driver activates said conveyor belt device, said conveyor belt device including a controller, the controller activates the rotary driver, the controller being programmable such that the controller activates the rotary driver at a programmed time, said conveyor belt device couples with a confining structure such that said conveyor belt device and the confining structure define the pet confinement, whereby the conveyor belt configuration of said conveyor belt device serves as the flooring for the pet confinement, said conveyor belt device moves pet waste deposited on the flooring of the pet confinement from the pet confinement; and
a receptacle, said receptacle disposed proximately below said conveyor belt device and not within said pet confinement, said receptacle receives pet waste from said conveyor belt device.

16. The pet confinement cleaning device of claim 15 wherein said conveyor belt device defines an open area through which said conveyor belt device moves pet waste to move pet waste from the pet confinement.

17. The pet confinement cleaning device of claim 16 wherein said receptacle is aligned below the open area defined by said conveyor belt device such that pet waste moved through the open area defined by said conveyor belt device falls under the force gravity to said receptacle, where the pet waste is received by said receptacle.

18. A pet confinement cleaning device for automatically removing pet waste from a pet confinement, said pet confinement cleaning device comprising:
a conveyor belt device, said conveyor belt device including a belt and at least one roller configured to operate as a conveyor belt configuration, said conveyor belt device couples with a confining structure such that when coupled, said conveyor belt device and the confining structure define the pet confinement, whereby the belt of said conveyor belt device serves as the flooring of the pet confinement, said conveyor belt device moves pet waste deposited on the belt from the pet confinement;
a rotary driver, said rotary driver drives the belt and the at least one roller such that the belt and the at least one roller operate as a conveyor belt configuration;
a controller, said controller activates said rotary driver, said controller being programmable such that said controller activates said rotary driver at a preprogrammed time; and
a receptacle, said receptacle disposed proximately below said conveyor belt device and not within the pet confinement, said receptacle receives pet waste from said conveyor belt device.

19. The pet confinement cleaning device of claim 18 wherein said conveyor belt device defines an open area through which the belt of said conveyor belt device moves pet waste in order to move pet waste from the pet confinement.

20. The pet confinement cleaning device of claim 19 wherein said receptacle is aligned below the open area defined by said conveyor belt device such that pet waste moved through the open area defined by said conveyor belt device falls under the force gravity to said receptacle, where the pet waste is received by said receptacle.

21. A pet confinement cleaning device for automatically removing pet waste from a pet confinement, said pet confinement cleaning device comprising:
a frame;
a drive roller, said drive roller secured to said frame such that said drive roller rotates about its longitudinal axis;
an idle roller, said idle roller secured to said frame such that said idle roller rotates about its longitudinal axis, said idle roller disposed on the same horizontal plane as said drive roller;
a feeding spool, said feeding spool secured to said frame such that said feeding spool rotates about its longitudinal axis, said feeding spool disposed below the horizontal plane on which the drive roller and the idle roller are disposed;
a collecting spool, said collecting spool secured to said frame such that said collecting spool rotates about its longitudinal axis, said collecting spool disposed below the horizontal plane on which the drive roller and the idle roller are disposed;
a belt, said belt including a first end and a second end, said belt wound on said feeding spool at the second end of said belt, said belt extending to and in mechanical contact with said idle roller, said belt extending to and in mechanical contact with said drive roller, said belt extending to and wound on said collecting spool at the first end of said belt, whereby said feeding spool, said drive roller, said idle roller, and said collecting spool are configured to operate as a conveyor belt configuration, said belt being the flooring for the pet confinement;
a rotary driver, said rotary driver drives the configuration of said belt, said drive roller, said idle roller, said feeding spool, and said collecting spool such that said belt, said drive roller, said idle roller, said feeding spool, and said collecting spoil operate as a conveyor belt configuration;
a controller, said controller activates said rotary driver, said controller programmable to activate said rotary driver at a preprogrammed time; and
a receptacle, said receptacle disposed proximately below the configuration of said belt, said drive roller, said idle roller, said feeding spool, and said collecting spool.

22. The pet confinement cleaning device of claim 21 wherein said belt is constructed of an absorbent material.

23. The pet confinement cleaning device of claim 21 wherein said belt is constructed of a disposable material.
